(19) United States
(12) Patent Application Publication
(10) Pub. No.: US 2013/0267445 A1
(43) Pub. Date: Oct. 10, 2013

(54) Antifoaming and Defoaming Agents for Drilling Fluids

(71) Applicant: ILF, Inc., Irving, TX (US)

(72) Inventor: Connie M. Hendrickson, Irving, TX (US)

(73) Assignee: ILF, Inc., Irving, TX (US)

(21) Appl. No.: 13/857,741

(22) Filed: Apr. 5, 2013

Related U.S. Application Data
(60) Provisional application No. 61/620,552, filed on Apr. 5, 2012.

(51) Int. Cl. C09K 8/035

(52) U.S. Cl. CPC C09K 8/035
USPC 507/136

(57) ABSTRACT

A method is provided for treating a drilling fluid to reduce foaming therein. The method comprises (a) providing a drilling fluid; and (b) treating the drilling fluid by adding a composition thereto which comprises (a) an alkylene glycol, (b) a polyol having first and second primary hydroxyl groups, (c) an unsaturated vegetable oil, and (d) an alkoxylated alcohol.

### CROSS-REFERENCE TO RELATED APPLICATION

This application claims the benefit of U.S. application No. 61/620,552 filed Apr. 5, 2012, having the same title, and which is incorporated herein by reference in its entirety.

### FIELD OF THE DISCLOSURE

The present disclosure relates generally to drilling fluid additives, and in particular, to antifoaming and defoaming agents for drilling fluids.

### BACKGROUND OF THE DISCLOSURE

The use of drilling fluids or muds in oil and gas exploration is well known. In a typical drilling operation, drilling fluid is pumped down the drill string, where it is discharged through ports in or near the drill bit. The used drilling fluid is then returned to the surface by way of the annulus formed between the drill pipe and the surfaces of the surrounding formation.

Drilling fluids perform a variety of functions in drilling operations, including cooling and lubricating the drill bit and drill string, removing cuttings generated during the drilling process and carrying them to the surface, suspending cuttings in the annulus when pumping stops, preventing squeezing in (or caving of) the formation, and preventing formation fluids from entering the annulus around the drill pipe.

### SUMMARY OF THE DISCLOSURE

In one aspect, a method is provided for treating a drilling fluid to reduce foaming therein. The method comprises (a) providing a drilling fluid; and (b) treating the drilling fluid by adding a composition thereto which comprises (a) an alkylene glycol, (b) a polyol having first and second primary hydroxyl groups, (c) an unsaturated vegetable oil, and (d) an alkoxylated alcohol.

In another aspect, a method is provided for treating a drilling fluid to reduce foaming therein. The method comprises (a) providing a drilling fluid; (b) treating the drilling fluid by adding a composition thereto which comprises by weight, based on the total weight of said composition, (a) 20% to 40% propylene glycol, (b) 10% to 20% glycerol, (c) an unsaturated vegetable oil, and (d) a linear ethoxylated alcohol; and (c) circulating the treated drilling fluid through a drill string.

### BRIEF DESCRIPTION OF THE DRAWINGS

FIG. 1 is an illustration of a mud circulation system (for an oil or natural gas well) within which the antifoaming and defoaming agents disclosed herein may be utilized.

### DETAILED DESCRIPTION

As used herein, the term “drill string” refers to a column, or string, or drill pipe that transmits drilling fluid (typically via mud pumps) and torque (typically via the top drive) to a drill bit. The drill string is typically hollow so that drilling fluid can be pumped down through it and circulated back up the annulus (that is, the void between the drill string and the casing or hole).

As used herein, the term “drilling fluid” is a fluid used to aid the drilling of boreholes into the earth. Liquid drilling fluid is often referred to as “drilling mud”.

One common problem encountered with the use of drilling fluids is foaming. During drilling operations, as the drilling fluid travels from the mud pit to the drill bit and back again, it may become impregnated or saturated with natural gas, carbon dioxide, or other gasses which commonly occur in subterranean formations. As the drilling fluid returns to the surface from the drill bit, the associated drop in pressure may cause the entrained gasses in the drilling mud to expand rapidly. This may result in foaming, in a manner similar to that which occurs when a cap is removed from a carbonated beverage. Left unchecked, foam formation can cause serious problems such as pump cavitations, undesired slurry densities, inadequate mixing and gas permeability issues.

In light of the foregoing, defoaming agents and antifoaming agents have become crucial components in many processes in the oil and gas industry. However, the emergence of higher industry standards and new, more challenging environmental regulations, such as those governing offshore drilling and completion operations, has placed increased demands on antifoaming and defoaming agents. There is thus a need in the art for antifoaming and defoaming agents that can meet these increased demands. In particular, there is a need in the art for antifoaming and defoaming agents that pose minimal risks to the environment, while also providing desirable performance characteristics.

It has now been found that the foregoing needs may be addressed through the use of the compositions and methodologies disclosed herein. These compositions and methodologies may be utilized to control, reduce or eliminate foaming in muds and other drilling fluids in situations where foaming is undesirable. Consequently, the drilling fluids may be maintained at a proper density for the drilling operation. In a preferred embodiment, the composition comprises (a) an alkylene glycol (preferably propylene glycol), (b) a polyol having first and second primary hydroxyl groups (preferably glycerol), (c) an unsaturated vegetable oil (preferably cottonseed oil), and (d) an alkoxylated alcohol (preferably a linear ethoxylated alcohol).

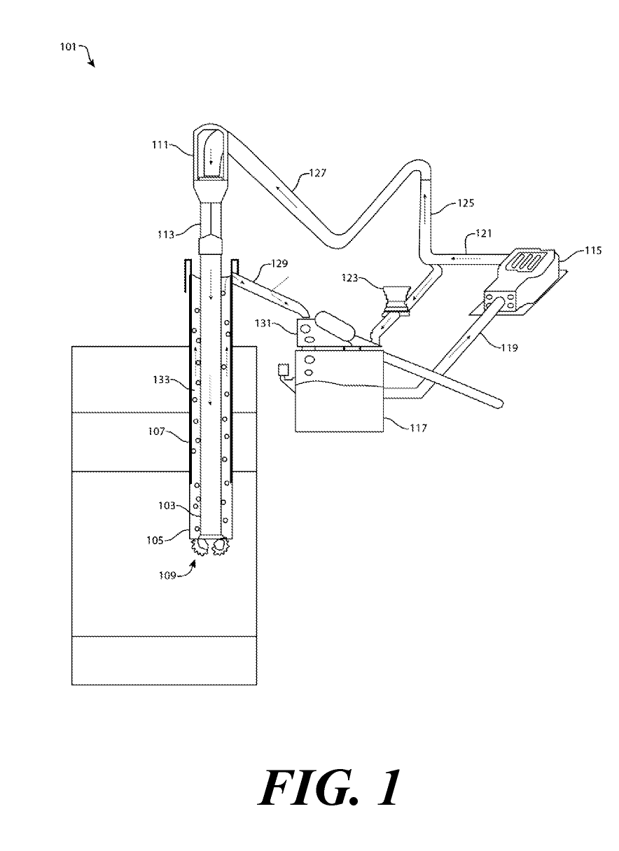

FIG. 1 illustrates a mud circulating system of the type commonly used in drilling operations, and in which the antifoaming and defoaming agents described herein may be utilized. The mud circulation system 101 depicted therein operates in conjunction with a drill pipe 103 which extends down a wellbore 105 equipped with a surface casing 107. The drill pipe 103 is equipped on one end with a drill bit 109, and is equipped on the other end with a swivel 111 and a kelly 113.

The mud circulation system 101 is equipped with a mud pump 115 which draws mud from a mud pit 117 by way of a mud suction line 119 and discharges the mud by way of a discharge line 121. The discharge line 121 is fitted with a mud mixer 123 which may be utilized to add the antifoaming and defoaming agents described herein to the mud, along with any other mud additives. The discharge line 121 is also fitted with a stand pipe 125 and a rotary pipe hose 127 by which mud may be injected into the drill pipe 103.

In operation, the mud pump 115 injects mud into the drill pipe 103, and the injected mud exits the drill pipe 103 near or through the drill bit 109. The mud then returns to the surface by way of the annulus 133 formed between the surface casing 107 and the drill pipe 103. In addition to cooling and lubricating the drill bit 109, the mud carries substrate debris back to the surface. The returned mud is transferred to the mud pit 117 by way of a mud return line 129. The mud return line 129 may be equipped with a shale shaker 131 or other mud filtering device to remove the debris from the mud so the mud can be recycled.

Various antifoaming or defoaming agents may be utilized in the compositions and methodologies disclosed herein, and these agents may be applied to the drilling fluid in a variety of ways. Preferably, the antifoaming or defoaming composition comprises (a) an alkylene glycol (preferably propylene glycol), (b) a polyol having first and second primary hydroxyl groups (preferably glycerol), (c) an unsaturated vegetable oil (preferably cottonseed oil), and (d) an alkoxylated alcohol (preferably a linear ethoxylated alcohol).

The antifoaming or defoaming compositions may be applied to the drilling fluid as oil-in-water dispersions or emulsions in which the oil phase contains at least one hydrophobic compound, and the aqueous phase contains at least one stabilizer and possibly a thickener. In some embodiments, the antifoaming or defoaming composition may be applied as oil-in-water emulsions which contain aliphatic alcohols having relatively high melting points, and hydrocarbons which are liquid at room temperature. The oil phase of the oil-in-water emulsions may, if required, also contain further components acting as antifoaming agents, such as non-aromatic hydrocarbons, fatty acids or derivatives thereof having relatively high melting points. Examples of the later include fatty acid esters, beeswax, Carnauba wax, Japan wax and montan wax.

In other embodiments, the antifoaming or defoaming composition may be applied to the drilling fluid as an oil-in-water emulsion whose oil phase contains an alcohol of at least 12 carbon atoms, fatty acid esters of alcohols of at least 22 carbon atoms and C₁- to C₃₆-carboxylic acids, or fatty acid esters of C₁₂- to C₂₂-carboxylic acids with monohydric to trihydric C₁- to C₁₈-alcohols. The oil phase may also contain a hydrocarbon having a boiling point above 200° C., or fatty acids of 12 to 22 carbon atoms in combination with polyglyceryl esters which are obtainable by at least 20% esterification of polyglycerol mixtures with at least one fatty acid of 12 to 36 carbon atoms. These oil-in-water emulsions may be stabilized with the aid of a water-soluble emulsifier.

In other embodiments, the antifoaming or defoaming composition may be applied to the drilling fluid as oil-in-water emulsions which contain, in the oil phase, (a) fatty acid esters of C₁₂- to C₂₂-carboxylic acids with monohydric to trihydric C₁- to C₂₂-alcohols, (b) polyglyceryl esters which are obtainable by at least 20% esterification of polyglycerols which have at least 2 glycerol units with at least one C₁₂- to C₃₆-fatty acid and (c) fatty acid esters of C₁₂- to C₂₂-carboxylic acids and polyalkylene glycols, the molar mass of the polyalkylene glycols being up to 5000 g/mol. The hydrophobic phase may, if required, contain further components, such as alcohols of at least 12 carbon atoms or hydrocarbons having a boiling point above 200° C. These oil-in-water emulsions may be stabilized with the aid of an emulsifier.

In other embodiments, the antifoaming or defoaming composition may be applied to the drilling fluid as oil-in-water emulsions in which the oil phase contains (a) at least one alcohol of at least 12 carbon atoms, distillation residues which are obtainable in the preparation of alcohols having a relatively high number of carbon atoms by oxo synthesis or by the Ziegler process, or mixtures of said compounds, and (b) at least one ester of a sugar alcohol having at least 4 OH groups or at least 2 OH groups and at least one intramolecular ether bond and a fatty acid of at least 20 carbon atoms in a molar ratio of 1 to at least 1, it being possible for some or all of the free OH groups of these esters to be esterified with C₁₂- to C₁₈-carboxylic acids.

In still other embodiments, the antifoaming or defoaming composition may be applied to the drilling fluid as oil-in-water emulsions which contain a hydrophobic phase comprising fatty acid esters of alcohols of at least 22 carbon atoms and C₁- to C₃₆-carboxylic acids, polyethylene waxes, natural waxes, hydrocarbons having a boiling point above 200° C. or fatty acids of 12 to 22 carbon atoms.

In some embodiments, the antifoaming or defoaming composition may contain from 10 to 90% by weight of a surface-active polyether, such as polyalkoxylated glycerol or polyalkoxylated sorbitol, and from 10 to 90% by weight of a fatty acid ester of polyhydric alcohols, such as mono- or diesters of fatty acids and polyethylene glycol and/or polypropylene glycol, the antifoaming or defoaming composition being free of any oils, amides, hydrophobic silica or silicones. The antifoaming or defoaming composition may also be applied to the drilling fluid as oil-in-water emulsions which contain, in the hydrophobic oil phase, 3-thiaalkan-1-ols, 3-thiaoxoalkan-1-ols, 3-thiadioxoalkan-1-ols, esters of said compounds or mixtures thereof.

Another class of antifoaming or defoaming agents which may be suitable for use in some of the compositions and methodologies described herein comprise ethylenebisstearamide or other aliphatic diamides together with at least one compound from the group consisting of the mono- and diesters of polyethylene glycol and fatty acids, sulfonated mineral oils and ethoxylation products of alcohols of 10 to 14 carbon atoms.

In still other embodiments, the antifoaming or defoaming composition may be applied to the drilling fluid as oil-in-water emulsions which contain at least one compound from the group consisting of the alcohols of at least 12 carbon atoms, alkoxylated fatty alcohols, mono-, di- and triglycerides of fatty acids, fatty acid esters of carboxylic acids of at least 12 carbon atoms and monohydric to tetrahydric alcohols of 1 to 24 carbon atoms, hydrocarbons having a boiling point above 200° C., fatty acids of 12 to 26 carbon atoms, 3-thiaalkan-1-ols, 3-thiaoxoalkan-1-ols, 3-thiadioxoalkan-1-ols and esters of thiaalkane compounds and whose aqueous phase contains at least one stabilizer and, if required, a thickener, if the oil-in-water dispersions contain (i) at least one polyglyceryl ester which is obtainable by at least 20% esterification of polyglycerol with a carboxylic acid of 12 to 36 carbon atoms and (ii) at least one bisamide of ethylenediamine and carboxylic acids of 10 to 36 carbon atoms.

In still other embodiments, the antifoaming or defoaming composition may be applied to the drilling fluid as oil-in-water emulsions which contain mixtures of (i) at least one polyglyceryl ester which is obtainable by at least 20% esterification of polyglycerol with a carboxylic acid of 12 to 36 carbon atoms and (ii) at least one bisamide of ethylenediamine and carboxylic acids of 10 to 36 carbon atoms as an additive for antifoams and/or deaerators based on oil-in-water dispersions.

Suitable compounds which may be used to form the hydrophobic phase of the oil-in-water dispersions used in making the antifoaming or defoaming compositions described herein include, for example, C₁₂- to C₄₈-alcohols, such as myristyl alcohol, cetyl alcohol, stearyl alcohol, palmityl alcohol, tallow fatty alcohol and behenyl alcohol, and synthetic alcohols, for example saturated, straight-chain, unbranched alcohols obtainable by the Ziegler process by oxidation of alkylaluminums. Synthetic alcohols may also be used for this purpose which are obtained by oxo synthesis. These alcohols may contain, for example, up to 48 carbon atoms in the molecule. For example, the antifoaming agent may contain mixtures of at least one C₁₂- to C₂₆-alcohol and at least one fatty alcohol having 28 to 48 carbon atoms in the molecule.

In some embodiments, the antifoaming or defoaming agent may comprise distillation residues which are obtainable in the preparation of alcohols having a relatively large number of carbon atoms by oxo synthesis or by the Ziegler process. Other suitable antifoaming agents include alkoxylated alcohols and alkoxylated distillation residues which are obtained in the preparation of alcohols by oxo synthesis or by the Ziegler process. The alkoxylated compounds may be obtained by reacting the long-chain alcohols or distillation residues with ethylene oxide or with propylene oxide or with a mixture of ethylene oxide and propylene oxide. In this case, first ethylene oxide and then propylene oxide can be subjected to an addition reaction with the alcohols or the distillation residues or the addition reaction may be carried out first with propylene oxide and then with ethylene oxide. In general, up to 5 mol of ethylene oxide or propylene oxide undergo the addition reaction per OH group of the alcohol. Particularly preferred from the group consisting of the alkoxylated compounds are those reaction products which are prepared by an addition reaction of 1 or 2 mol of ethylene oxide with 1 mol of fatty alcohol or distillation residue.

The aforementioned fatty alcohols having at least 12 carbon atoms in the molecule may be used in combination with other compounds having antifoaming properties. Such compounds may include fatty acid esters of C₁₂- to C₂₆-carboxylic acids of, for example, C₁₂-C₂₂-carboxylic acids, with monohydric to tetrahydric C₁-C₂₄-alcohols, preferably C₁-C₂₂-alcohols, and more preferably C₃-C₁₈-alcohols. The fatty acids on which these esters are based are, for example, lauric acid, myristic acid, palmitic acid, stearic acid, arachidic acid, behenic acid, lignoceric acid and cerotic acid. Palmitic acid, stearic acid or behenic acid is preferably used. Monohydric, dihydric, trihydric, tetrahydric, or polyhydric C₁- to C₂₄-alcohols can be used for esterifying the carboxylic acids. Suitable monohydric alcohols include, for example, methanol, ethanol, propanol, butanol, hexanol, dodecanol, stearyl alcohol and behenyl alcohol. Suitable dihydric alcohols include, for example, ethylene glycol. Suitable trihydric alcohols include, for example, glycerol. Suitable tetrahydric alcohols include, for example, pentaaerythritol. The polyhydric alcohols may be completely or only partially esterified.

Another class of antifoaming or defoaming agents which may be suitable in some of the compositions and methodologies described herein are polyglyceryl esters. Such esters may be prepared, for example, by esterifying polyglycerols which contain at least 2 glycerol units with at least one C₁₂- to C₃₆-carboxylic acid. The polyglycerols may be obtained, for example, by alkali-catalyzed condensation of glycerol at relatively high temperatures or by reaction of epichlorohydrin with glycerol in the presence of acidic catalysts. The polyglycerols usually contain from at least 2 to about 30, preferably from 2 to 12, glycerol units. Commercial polyglycerols contain mixtures of polymeric glycerols, for example mixtures of diglycerol, triglycerol, tetraglycerol, pentaglycerol and hexaglycerol and, if required, polyglycerols having a higher degree of condensation. The degree of esterification of the OH groups of the polyglycerols is from at least 20% to 100%, and preferably from 60% to 100%. The long-chain fatty acids used for the esterification may be saturated or ethylenically unsaturated. Suitable fatty acids may include, for example, lauric acid, myristic acid, palmitic acid, stearic acid, arachidic acid, behenic acid, oleic acid, hexadecenoic acids, elaidic acid, eicosenoic acids, docosenoic acids, such as erucic acid, or polyunsaturated acids, such as octadecenedienoic acids and octadecenetrienoic acids (e.g. linoleic acid and linolenic acid), and mixtures of such carboxylic acids.

Other antifoaming or defoaming agents which may be used in the compositions and methodologies described herein, and which may be used either alone or together with at least one alcohol of at least 12 carbon atoms, are esters of a sugar alcohol having at least 4 OH groups or at least 2 OH groups and at least one intramolecular ether bond, and a fatty acid having at least 20 carbon atoms in the molecule in a molar-ratio of 1 to at least 1, it being possible for some or all of the free OH groups of these esters to be esterified with C₁₂- to C₁₈-carboxylic acids. Esters of tetritols, pentitols and/or hexitols with fatty acids of at least 22 carbon atoms in a molar ratio of 1 to at least 1.9 may be used. Esters of mannitol and/or sorbitol with behenic acid in a molar ratio of 1 to at least 1, preferably 1 to at least 1.9, may also be used. In addition to the sugar alcohols, sorbitol and mannitol, other sugar alcohols which may be used include adonitol, arabitol, xylitol, dulcitol, pentaerythritol, sorbitan and erythritol. Sugar alcohols are understood as meaning the polyhydroxy compounds which are formed from monosaccharides by reduction of the carbonyl function, and which are not themselves sugars. The anhydro compounds which form from sugar alcohols as a result of intramolecular elimination of water may also be used. These include, for example, antifoaming agents obtained when sugar alcohols are esterified with C₂₂- to C₃₀-fatty acids. If the sugar alcohols are only partly esterified with a fatty acid of at least 20 carbon atoms, the unesterified OH groups of the sugar alcohol can be esterified with another carboxylic acid, for example a C₁₂- to C₁₈-carboxylic acid.

The hydrophobic phase of the antifoaming or defoaming agents utilized in the compositions and methodologies disclosed herein may furthermore contain from 1 to 100% by weight of a 3-thiaalkan-1-ol, 3-thiaoxoalkan-1-ol or 3-thiadioxoalkan-1-ol, or an ester of said compounds or of mixtures thereof.

Further compounds suitable as antifoaming or defoaming agents in the compositions and methodologies disclosed herein may include ketones having melting points above 45° C. These may be used together with fatty alcohols whose melting points are above 40° C. The reaction products of, for example, mono- and/or diglycerides with dicarboxylic acids and reaction products of glycerol with dicarboxylic acids, which reaction products are esterified with at least one C12- to C36-fatty acid, may also be used as additives for the hydrophobic phase of the antifoaming or defoaming agents described herein.

Other compounds which may enhance the efficiency of long-chain alcohols as antifoaming or defoaming agents and which may be used in the compositions and methodologies described herein include, for example, polyethylene waxes having a molar mass of at least 2000 and natural waxes, such as beeswax or Carnauba wax.

Further possible components of the antifoaming or defoaming compositions utilized herein include hydrocarbons having a boiling point above 200° C. (determined at atmospheric pressure). These include liquid paraffins and paraffin mixtures such as those referred to as white oil. Paraffins whose melting point is, for example, above 50° C. may also be used.

In some embodiments, the antifoaming or defoaming agents used in the compositions and methodologies described herein may contain, in the hydrophobic phase, combinations of (i) at least one polyglyceryl ester which is obtainable by at least 20% esterification of polyglycerol with a carboxylic acid of 12 to 36 carbon atoms and (ii) at least one bisamide of ethylenediamine and carboxylic acids of 10 to 36 carbon atoms.

The amount of the polyglyceryl esters in the hydrophobic phase of the oil-in-water dispersions may be, for example, from 0.5% to 80%, or from 2% to 20%, by weight. The weight ratio of (i) polyglyceryl esters to (ii) bisamides may be, for example, from 10:1 to 1:10, or from 3:1 to 1.5:1.

In some embodiments, the antifoaming or defoaming agent may contain one or more performance boosters. For example, an oil-based antifoaming agent may contain a wax and/or hydrophobic silica to boost the performance. Waxes that may be used for this purpose include, for example, ethylene bis stearamide (EBS), paraffinic waxes, ester waxes and fatty alcohol waxes.

### EXAMPLE 1

The present example illustrates the synthesis of a particular, non-limiting embodiment of an antifoaming and defoaming agent in accordance with the teachings herein.

An antifoaming and defoaming composition was produced by mixing together the materials in the amounts indicated in TABLE 2:

TABLE 2
Antifoaming and Defoaming Composition

| | % by Weight |
|---|---|
| | (based on the total weight of the |
| Component | composition) |
| Propylene glycol | 15 |
| Glycerol | 15 |
| Unsaturated vegetable oil (cottonseed) | 60 |
| Linear ethoxylated alcohol (surfactant) | 10 |

The materials were mixed with a high speed rotary mixer until a smooth mixture was obtained.

### EXAMPLE 2

The following example illustrates the efficacy of the antifoaming and defoaming compositions disclosed herein in treating drilling fluids.

The efficacy of the composition of EXAMPLE 1 was tested by using a mud mixer to slowly add 5 gallons of the composition to the mud in the mud pit of an oil well. The composition was added to the mud over a 60 minute interval. At the time the composition was added, the mud already had an 8-12 inch head of foam due to the previous addition of a hole lubricant. As the treated mud began to come out of the mud return line, there was no visible foam in the mud. Moreover, by the time the treated mud completed a cycle of the mud circulation system, the mud pits were also observed to be free of foam.

At that time, the well took a gas kick. This typically causes the mud to become saturated with gas, and also typically causes the mud to become lighter. However, the treated mud was observed to maintain its true mud weight for 3 more cycles through the mud circulation system before finally being overwhelmed. Notably, the volume of gas in the gas kick was so large that the well had to be shut down to maintain control over it.

Various modifications may be made to the compositions and methodologies disclosed herein. For example, various unsaturated oils may be used in the compositions and methodologies described herein. Preferably, the unsaturated oils utilized are vegetable oils. TABLE 1 sets forth some of the properties of some vegetable oils which may be used in the compositions and methodologies described herein:

TABLE 1
Vegetable Oils
Vegetable Oils - Summary Table of Characteristics

| | | | Mono | Poly Unsaturated Fatty Acids | | | | | | | |
|---|---|---|---|---|---|---|---|---|---|---|---|
| | | | Mono | Total | Alpha | | | | | | |
| | Sum of | Sat. | Unsaturated | Poly | Linolenic | Linoleic | Ratio | | | | |
| | Total | Saturated | Oleic Acid | Unsaturated | (Omega-3) | (Omega-6) | LA/LNA | Melting Point | | | |
| | Fat % | Fat % | (Omega-9) % | % | (LNA) % | (LA) % | (ideal = 3:1) | ° F. | | ° C. | |
| Flaxseed Oil | 100 | 8 | 21 | 71 | 57 | 14 | 0.2 | −11° | F. | −24° | C. |
| Fish Oil | 99 | 25 | 24 | 50 | 30 | 20 | 0.7 | — | | — | |
| Cottonseed Oil | 100 | 28 | 18 | 54 | 7 | 47 | 7 | −55° | F. | −48° | C. |
| Walnut Oil | 100 | 8 | 22 | 70 | 12 | 58 | 5 | — | | — | |
| Hempseed Oil | 85 | 9 | 13 | 63 | 5 | 58 | 10 | 18° | F. | −8° | C. |
| Almond Oil | 100 | 8 | 73 | 19 | — | — | — | — | | — | |
| Olive Oil | 98 | 11 | 79 | 8 | 1 | 7 | 7 | −42° | F. | −41° | C. |
| Grapeseed Oil | 100 | 14 | 57 | 29 | 0 | 29 | 100 to 1 | 14° | F. | 10° | C. |
| Canola Oil | 100 | 7 | 58 | 35 | 14* | 21 | 1.5 | 14° | F. | 10° | C. |
| Safflower Oil | 100 | 8 | 14 | 78 | 0 | 78 | 100 to 1 | 2° | F. | −17° | C. |
| Sunflower Oil | 100 | 11 | 20 | 69 | 0 | 69 | 100 to 1 | 2° | F. | −17° | C. |
| Soybean Oil | 100 | 15 | 24 | 61 | 7* | 54 | 8 | −5° | F. | −21° | C. |
| Corn Oil | 100 | 14 | 25 | 61 | 1 | 60 | 60 | 12° | F. | −11° | C. |
| Peanut Oil | 100 | 18 | 48 | 34 | 0 | 34 | 100 to 1 | 28° | F. | −2° | C. |
| Coconut Oil | 100 | 92 | 6 | 2 | 0 | 2 | 100 to 1 | 75° | F. | 25° | C. |
| Palm Oil | 100 | 52 | 38 | 10 | | | | | | | |
| Palm Kernel Oil | 100 | 86 | 12 | 2 | 0 | 2 | 100 to 1 | 75° | F. | 24° | C. |

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

### REFERENCE NUMBER LISTING

101: mud circulation system
103: drill pipe
105: wellbore
107: surface casing
109: drill bit
111: swivel
113: kelly
115: mud pump
117: mud pit
119: suction line
121: discharge line
123: mud mixer
125: stand pipe
127: rotary pipe hose
129: mud return line
131: shale shaker
133: annulus (between casing and drill pipe)

What is claimed is:

1. A method for treating a drilling fluid to reduce foaming therein, comprising:
providing a drilling fluid; and
treating the drilling fluid by adding a composition thereto which comprises (a) an alkylene glycol, (b) a polyol having first and second primary hydroxyl groups, (c) an unsaturated vegetable oil, and (d) an alkoxylated alcohol, thereby obtaining treated drilling fluid.

2. The method of claim 1, wherein said alkylene glycol is selected from the group consisting of ethylene glycol and propylene glycol.

3. The method of claim 1, wherein said alkylene glycol is propylene glycol.

4. The method of claim 1, wherein said polyol is glycerol.

5. The method of claim 1, wherein said unsaturated vegetable oil is selected from the group consisting of canola oil, cottonseed oil, olive oil, corn oil and safflower oil.

6. The method of claim 1, wherein said unsaturated vegetable oil is cottonseed oil.

7. The method of claim 1, wherein said alkoxylated alcohol is an ethoxylated alcohol.

8. The method of claim 1, wherein said alkoxylated alcohol is linear.

9. The method of claim 1, wherein said alkylene glycol is present in said composition in an amount of 5% to 60% by weight, based on the total weight of said composition.

10. The method of claim 1, wherein said alkylene glycol is present in said composition in an amount of 10% to 50% by weight, based on the total weight of said composition.

11. The method of claim 1, wherein said alkylene glycol is present in said composition in an amount of 20% to 40% by weight, based on the total weight of said composition.

12. The method of claim 1, wherein said alkylene glycol is present in said composition in an amount of about 30% by weight, based on the total weight of said composition.

13. The method of claim 1, wherein said polyol is present in said composition in an amount of 5% to 25% by weight, based on the total weight of said composition.

14. The method of claim 1, wherein said polyol is present in said composition in an amount of 10% to 20% by weight, based on the total weight of said composition.

15. The method of claim 1, wherein said polyol is present in said composition in an amount of about 15% by weight, based on the total weight of said composition.

16. The method of claim 1, wherein said unsaturated vegetable oil is present in said composition in an amount of 30% to 90% by weight, based on the total weight of said composition.

17. The method of claim 1, wherein said unsaturated vegetable oil is present in said composition in an amount of 45% to 75% by weight, based on the total weight of said composition.

18. The method of claim 1, wherein said unsaturated vegetable oil is present in said composition in an amount of 50% to 70% by weight, based on the total weight of said composition.

19. The method of claim 1, wherein said unsaturated vegetable oil is present in said composition in an amount of about 60% by weight, based on the total weight of said composition.

20. The method of claim 1, wherein said alkoxylated alcohol is present in said composition in an amount of 2% to 20% by weight, based on the total weight of said composition.

21. The method of claim 1, wherein said alkoxylated alcohol is present in said composition in an amount of 5% to 15% by weight, based on the total weight of said composition.

22. The method of claim 1, wherein said alkoxylated alcohol is present in said composition in an amount of 8% to 12% by weight, based on the total weight of said composition.

23. The method of claim 1, wherein said alkoxylated alcohol is present in said composition in an amount of about 10% by weight, based on the total weight of said composition.

24. The method of claim 1, further comprising:
circulating the treated drilling fluid through a drill string.

25. A method for treating a drilling fluid to reduce foaming therein, comprising:
providing a drilling fluid;
treating the drilling fluid by adding a composition thereto which comprises by weight, based on the total weight of said composition, (a) 20% to 40% propylene glycol, (b) 10% to 20% glycerol, (c) an unsaturated vegetable oil, and (d) a linear ethoxylated alcohol; and
circulating the treated drilling fluid through a drill string.
